(19) United States
(12) Patent Application Publication
(10) Pub. No.: US 2026/0184480 A1
(43) Pub. Date: Jul. 2, 2026

(54) SCREW TOP SMART CAP

(71) Applicant: RxCap, Inc., Lynnfield, MA (US)

(72) Inventors: Sreeram Ramakrishnan, Lynnfield, MA (US); Michael Furlotti, Ross, CA (US); Ram Subramanian, Fremont, CA (US)

(21) Appl. No.: 19/438,377

(22) Filed: Dec. 31, 2025

Related U.S. Application Data
(60) Provisional application No. 63/740,451, filed on Dec. 31, 2024.
(60) Provisional application No. 63/851,094, filed on Jul. 25, 2025.

(51) Int. Cl. B65D 51/24; A61J 1/14; B65D 50/04

(52) U.S. Cl. CPC B65D 51/245; A61J 1/1418; B65D 50/041; A61J 2200/30; A61J 2200/70

(57) ABSTRACT

A cap for releasably covering a container includes a first cap section engageable with the container, a second cap section releasably engageable with the first cap section, engaging means provided for the first and second cap sections and movable between an engaged position and a released position, the engaging means causing the first cap section to move with the second cap section when in the engaged position, and allowing the second cap section to move relative to the first cap section when in the released position, a position sensor configured to detect relative positions between the first and second cap sections; and a controller configured to receive signals from the position sensor and output information based on the received signals.

### CROSS-REFERENCE TO RELATED APPLICATIONS

This application claims the benefit under 35 U.S.C. § 119(e) of U.S. Provisional Patent Application No. 63/740,451 , filed Dec. 31, 2024, and U.S. Provisional Patent Application No. 63/851,094 , filed Jul. 25, 2025, the entireties of which are incorporated herein by reference.

### FIELD OF THE INVENTION

The invention relates to a screw top smart cap, particularly a screw top smart cap with smart features usable with child-proof or child-resistant locking mechanisms for medication containers. For example, the smart cap is usable with push-and-turn child-resistant locking mechanisms.

### BACKGROUND OF THE INVENTION

Medication non-compliance is a major problem in health care. Medications in the form of pills, capsules, gel-caps, pellets, tablets, etc., are typically provided to a user in a disposable plastic container with a cap, such as a child-resistant cap. When physicians prescribe medications, they typically advise the patients of a proper medication administration, such as to take the medication at appropriate times in appropriate quantities, to continue taking the medication for the full prescribed regimen, even if the patient feels better, etc. Unfortunately, many patients exhibit poor compliance in properly following the regimens set out by their physicians.

A variety of products and techniques for reminding patients to take their medications, as prescribed, are known. Some compliance intervention systems offered by health care providers are designed to remind the patient to take the medication and alert a remote caregiver if the patient does not comply with taking the medication as prescribed. Some of these compliance intervention systems include sensors/reminders in the home, a network connection, and outbound messaging to a caregiver or even back to the patient.

Various attempts have been made to try to increase and improve the compliance of patients in the taking of their medications. Most of these systems are reminder systems. For example, there are a large number of pillbox systems that marry alarm clocks to medication containers to remind patients when it is time to take their medications.

U.S. Patent Application Publication No. 2007/0016443, for example, describes a method of providing a feedback scheme for medication to determine if a patient is complying with a specific schedule for the medication. This is accomplished by applying a special cap to a regular pill container. A sensor senses when the cap is opened and closed. A weight sensor may be provided to determine how many pills have been removed from the container. Further, the patent application publication describes the use of a pillbox with several compartments for storing pills.

Child-resistant caps are used to prevent young children from accessing contents of a bottle or a container so as to prevent consumption. An objective of the child-resistant closure mechanism is the requirement for multiple steps, which are not obvious or intuitive to young children, to remove the cap from the bottle or the container. The complexity of child-resistant caps, however, makes it difficult to incorporate smart features that are useful in improving compliance and monitoring usage and tampering. The present invention improves prior systems and overcomes the prior systems'deficiencies.

### SUMMARY OF THE INVENTION

In one aspect, the invention relates to a cap for releasably covering a container, the cap comprising first cap section engageable with the container, a second cap section releasably engageable with the first cap section, engaging means provided for the first and second cap sections and movable between an engaged position and a released position, the engaging means causing the first cap section to move with the second cap section when in the engaged position, and allowing the second cap section to move relative to the first cap section when in the released position, a position sensor configured to detect relative positions between the first and second cap sections, and a controller configured to receive signals from the position sensor and output information based on the received signals.

In another aspect, the invention relates to cap for releasably covering a container, comprising: a cap section engageable with the container to releasably cover the container; engaging means provided for the cap section and movable between a first position and a second position, the engaging means allowing the cap section to be removed from the container when in the first position, and not allowing the cap section to be removed from the container when in the second position; a position sensor configured to detect a relative position of the cap section; and a controller configured to receive signals from the position sensor and output information based on the received signals.

In a further aspect, the invention relates to method of releasably covering a container with a cap, the cap comprising at least one cap section engageable with the container, engaging means provided for the at least one cap section and movable between a first position and a second position, the engaging means allowing the cap section to be removed from the container when in the first position, and not allowing the cap section to be removed from the container when in the second position, and a position sensor configured to detect a relative position of the at least one cap section, the method comprising receiving signals from the position sensor when the cap is being manipulated, both when the engaging means is in the first position and when the engaging means is in the second position; and determining a disposition of the cap and outputting information based on the received signals.

Aspects and advantages of the present invention will become apparent when the description below is read in conjunction with the accompanying drawings.

### BRIEF DESCRIPTION OF THE DRAWINGS

FIG. 1 is a cross-sectional view of an embodiment of the cap of the present invention mounted on a container.

FIG. 2 is a cross-sectional view of an embodiment of the cap of the present invention separated from the container.

FIG. 3 is a perspective view of an embodiment of the cap of the present invention.

FIG. 4 is a cross-sectional perspective view of an embodiment of the cap of the present invention.

FIGS. 5A and 5B are cross-sectional views of an embodiment of the cap of the present invention, with FIG. 5A being a side view and FIG. 5B being a perspective view from below.

FIGS. 6A and 6B are perspective views of parts of the cap of the present invention.

FIG. 7 is a perspective view of a control substrate of an embodiment of the cap of the present invention.

FIG. 8 is a plan view of a control substrate of an embodiment of the cap of the present invention.

FIG. 9 is a schematic view of a control system of an embodiment of the cap of the present invention.

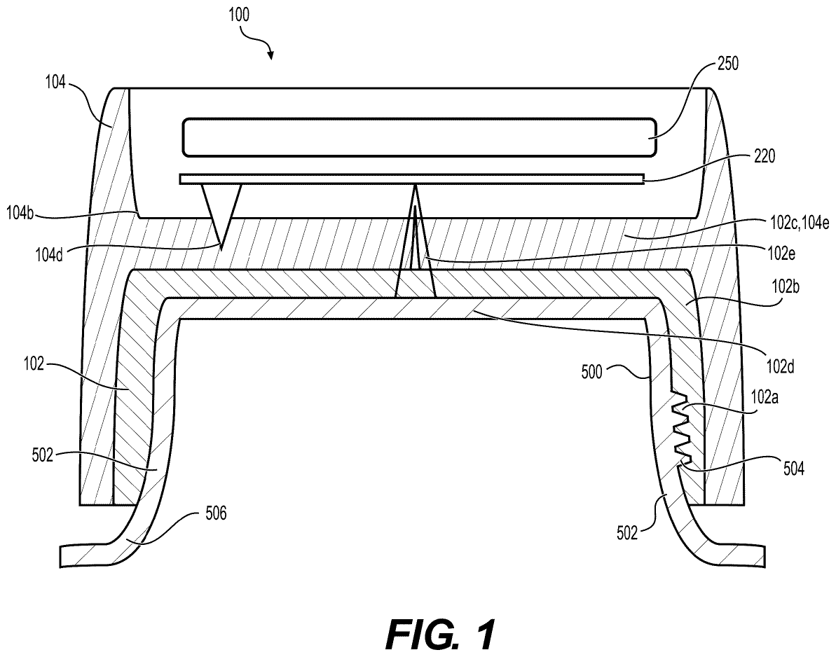

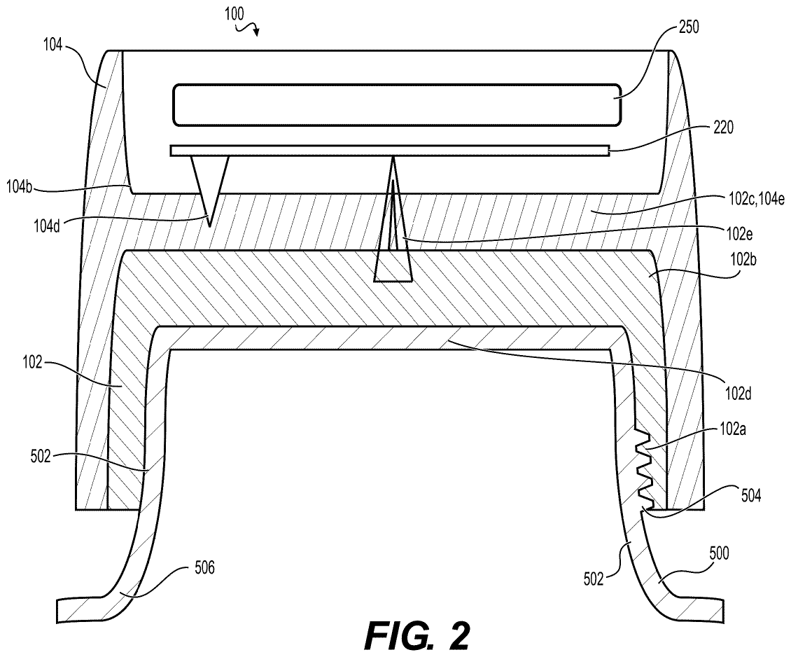

### DETAILED DESCRIPTION OF THE PREFERRED EMBODIMENTS

The present invention relates to an apparatus, method and system for using a child-resistant smart cap with a container for articles or other materials, particularly medicine for a patient, and for monitoring its usage. In a preferred embodiment, the dispensed medicine is in the form of pills. The term “pills,” as used herein, refers to any of capsules, gel-caps, pellets, tablets, or the like, in any particular shape or size. However, as would be understood by one of ordinary skill in the art, the present invention is not limited to only containing and capping medicine of a specific, uniform size, but may be used for medicines in other forms, such as creams, liquids, drops, etc. Further, the present invention may be used for containing and capping any other suitable items or material, especially those in which compliance is monitored.

The figures show a smart cap 100 in accordance with preferred embodiments of the invention. The invention herein is directed toward a smart cap for medication containers, such as container or bottle 500, which includes a container neck 502 having external threads 504. Some embodiments are directed toward a child-resistant smart cap that may be fitted on such medication containers. In various embodiments, the disclosed smart cap wirelessly transmits medication-related information to a computing device for further processing.

The smart cap 100 is of a concave design and includes a concave inner cap 102 having interior threads 102a for engaging external threads 504 of container 500, as well as a fixed shell 102b. Without any child-resistant features, the inner cap 102 would function as a standard container cap that could be secured to a container by simply twisting the cap by hand relative to the container (e.g., in a clockwise direction) so that the complementary threads engage, or be removed from the container by twisting the cap in the opposite direction (e.g., in a counterclockwise direction). However, in a preferred embodiment, the smart cap 100 includes child-resistant features and further includes a rotating over cap 104 that is disposed over the inner cap 102 in a concentric manner. The inner cap 102 is further provided with detents 102c that project upward from fixed shell 102b, whereas over cap 104 is provided with downward projecting bosses 104a that can engage with detents 102c when the child-resistant features are engaged. Any known spring mechanism (not shown) can be used to keep the over and inner caps 104, 102 separated when no or insufficient pressing force is applied to the over cap 104, in which case detents 102c will be separated from the projecting bosses 104a. Under such conditions, inner cap 102 will not spin even if over cap 104 is rotated. However, if a downward pressing force sufficient to overcome the force of the spring mechanism (i.e., a force that is greater than a force attainable by a typical child) is applied, projecting bosses 104a will engage with detents 102c and inner cap 102 will spin along with rotation of over cap 104. If such downward pressure is accompanied with counterclockwise rotation, the smart cap 100 can be unthreaded and removed from container 500, whereas if the downward pressure is accompanied with clockwise rotation, the smart cap 100 can be threaded onto the container.

While the described embodiment is directed to a smart cap with push-and-turn child-resistant features, the invention is not limited thereto. For example, the described modifications can be readily applied, with certain modifications, to smart caps with other child-resistant features, such as, squeeze-and-turn, squeeze-and-pull, and rim-snap closures. Squeeze-and-turn caps require squeezing the sides of the cap while turning to release the closure, and can include detents that project outward from circumferential sides of fixed shell 102b and inward projecting bosses on over cap 104. Squeeze-and-pull type caps require squeezing the sides of the cap while pulling it upwards to open. Rim-snap closures feature a snap-on rim that needs to be disengaged by applying pressure to a specific area before the cap can be twisted off. Other known capping features can also be suitable, such as those with a locking thumb tab, or even those that engage with locking features on the container, such as those that include a thumb tab on the rim of the container.

Smart cap 100 is preferably provided with additional components to achieve desired operation and performance of its smart features. These components include a central processing unit (CPU) or printed circuit board assembly (PCBA) as well as appropriate memory, such as a read only memory (ROM) and/or a random access memory (RAM), to control the device, a communications module, such as 5G cellular module or a Bluetooth® module (or other wired or wireless module) for remote communication, a global positioning system (GPS) module, an accelerometer, various sensors such as temperature and humidity sensors, a pressure sensor, and contact sensors, a battery, such as a rechargeable battery, lighting unit(s) such as light emitting diodes (LEDs), a piezoelectric element/device or speaker for audible alerts, one or more buttons or switches, and a display such as an LCD display. Sensors can also be provided to determine whether the child-resistant features have been engaged, whether the over cap 104 is being rotated, and whether smart cap 100 has been removed.

In more detail, smart cap 100 includes, in the over cap 104, a PCBA fixture 104b, on which PCBA (controller) 220 is mounted, a battery recess 104c where a battery 250 is mounted, and a rotation sensor or switch 104d for detecting rotation of the smart cap. The inner cap 102 includes a plunger plate 102d on which a plunger 102e is provided.

Rotation sensor or switch 104d can be mounted on PCBA 220, which is mounted in the over cap 104, and can be in the form of a single switch or plural switches. In one embodiment, two switches 104d-1, 104d-2 are provided on PCBA 220 or PCBA fixture 104b and a switch actuator 102f is disposed on inner cap 102 and projects through a recess 104e in over cap 104. The recess 104e is disposed so as to be situated between switches 104d-1, 104d-2, and switch actuator 102f projects through recess 104e so as also to be situated between switches 104d-1, 104d-2. When the child-resistant features are engaged as over cap 102 is depressed and the over cap is rotated, the bosses will engage the detents so as to allow the inner cap to rotate with the over cap. During such engagement and movement, the switch actuator 102f moves with the inner cap 102 somewhat relative to the PCBA fixture 104b. With such relative movement, the switch actuator 102f will contact either switch 104d-1 or switch 104d-2. In particular, if rotated to the right in the figure, the switch actuator 102f will contact switch 104d-2, and if rotated to the left, it will contact switch 104d-1. By sensing which switch has been contacted, controller (PCBA) 220 can determine both whether the child-resistant features have been engaged and which direction the smart cap is rotating.

Controller 220 can also determine whether smart cap 100 has been removed from container 500 using plunger 102e, which is preferably spring-loaded and can press a switch or trigger a sensor 220a on or near the PCBA 220. Any known proximity sensor can be used instead of the switch. Detection of removal of the smart cap can be recorded by the controller. The controller can further determine that the smart cap 100 has not been placed back on the bottle or container by detecting that the plunger 102e has not engaged the switch or proximity sensor within a specified time period. In addition, the controller can determine tampering if it detects turning of the cap with the child-resistant locking feature not being engaged.

In another embodiment, a depression switch or sensor 220b can be provided, on or between over cap 104 and/or inner cap 102, to determine whether over cap 104 has been sufficiently depressed toward inner cap 102, which will indicate that the child-resistant features have been engaged.

The container 500 can be provided with a radio frequency identification (RFID) tag 500a affixed thereto. Smart cap 100 can be provided with an RFID reader and controller 220 can be programmed to read RFID tags using the reader in order to ensure that the properly corresponding smart cap is used to cover the assigned container. The RFID tag will preferably be read when the cap is closed. The controller 220 can issue an alert if the cap is placed on the wrong bottle.

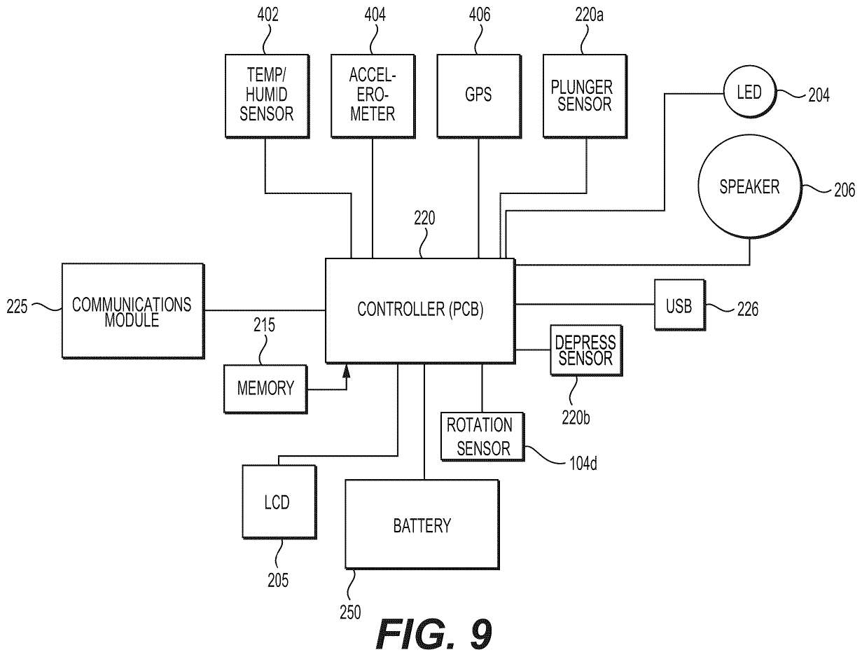

FIG. 9 is a schematic diagram of the foregoing electrical/electronic components of the system. Controller 220 of the smart cap 100 can be in the form of a PCB, which receives signals from and transmits signals to the several electrical components of the smart cap 100. Controller 220 is provided with any suitable memory 215 that it can use as a workspace and to store and retrieve data and programs. The smart cap 100 can be provided with a temperature and/or humidity sensor 402, an accelerometer 404, and a global positioning system (GPS) unit 406 in communication with controller 220. These sensors can be of any configuration known to those in the art. The temperature and/or humidity sensor 402 can sense ambient temperature and/or humidity conditions of the smart cap 100 and can convert those conditions into an electrical signal to supply to controller 220.

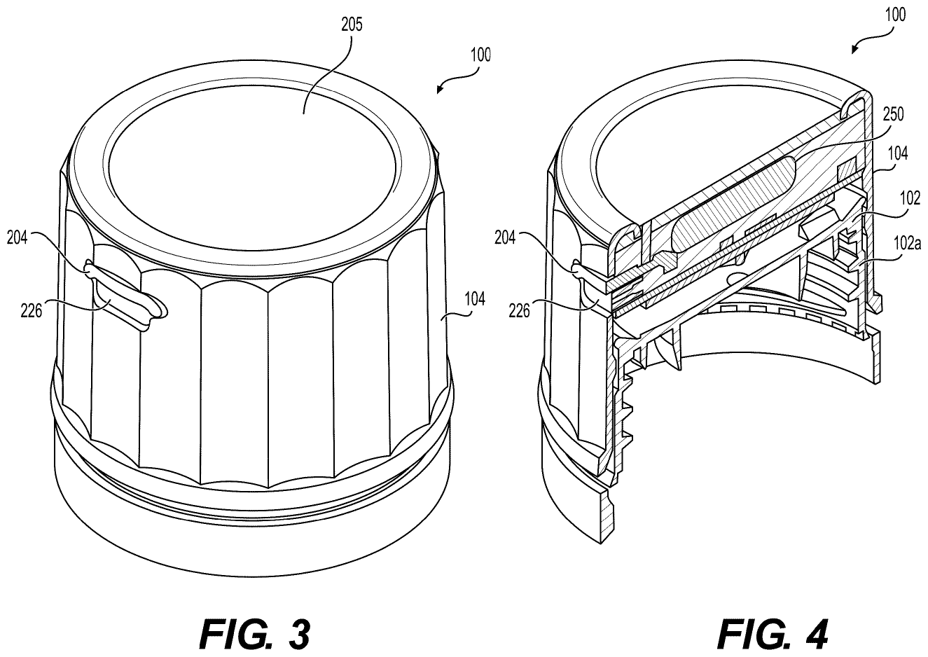

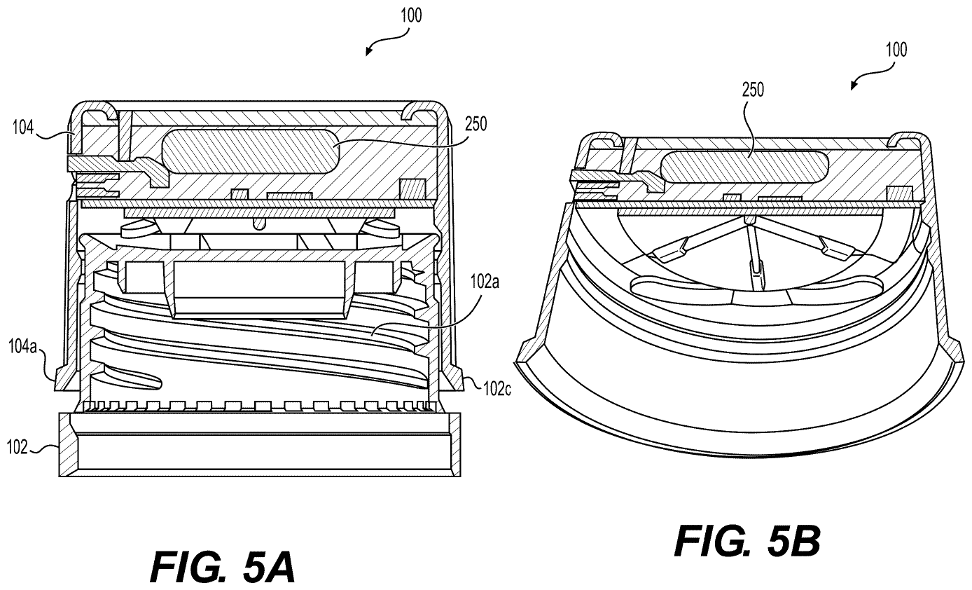

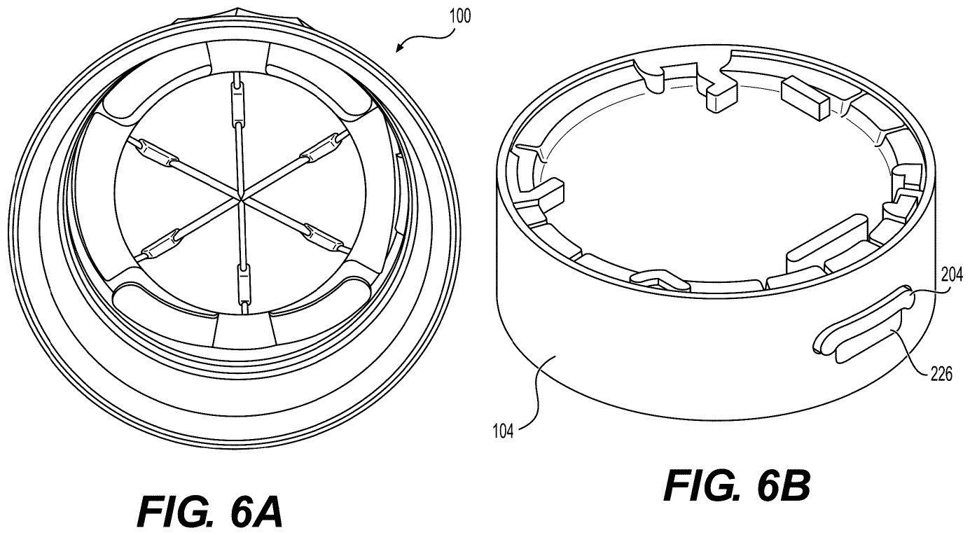

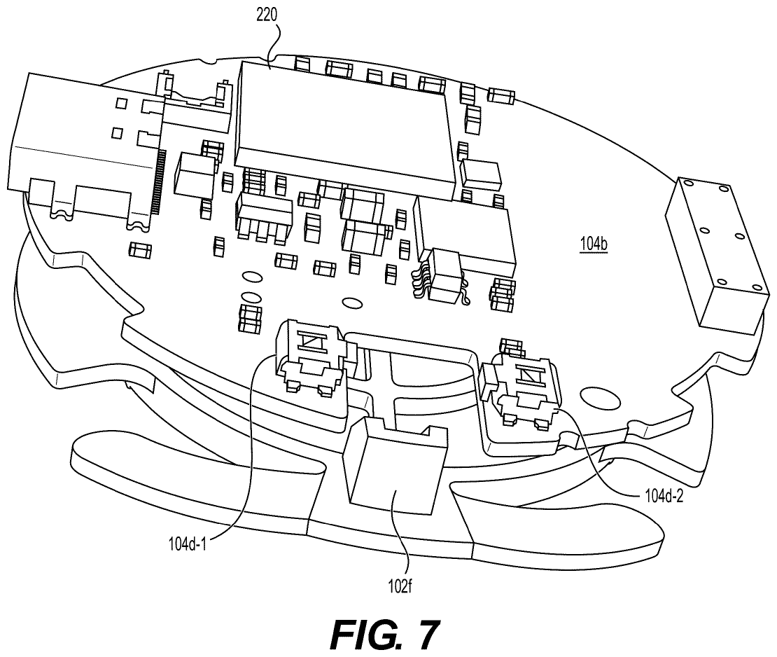

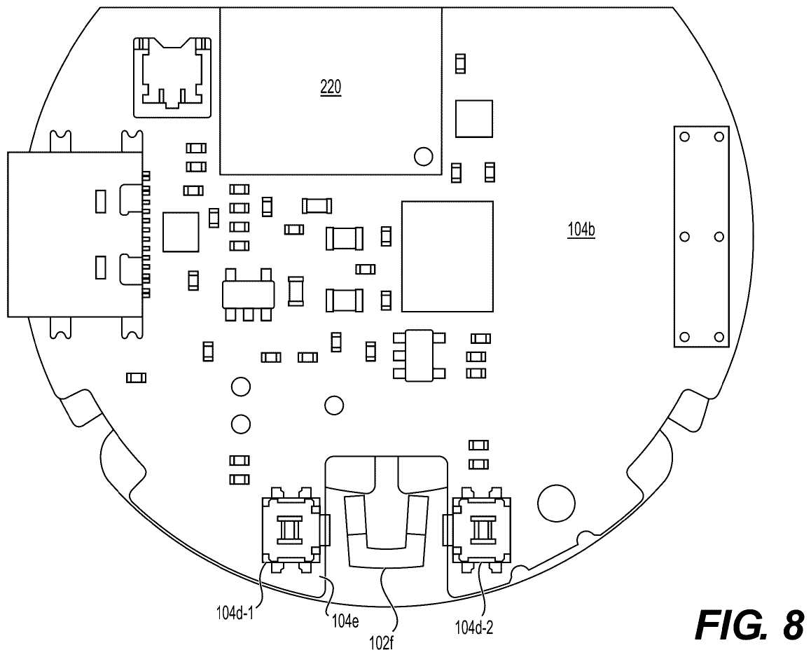

The smart cap 100 may also have one or more LEDs 204 placed thereon. The LEDs may be illuminated in order to alert a user when it is time to take his or her medication, as will be discussed more fully below. As would be understood by one having ordinary skill in the art, multiple color LEDs may be used. Further, the location of the LEDs is not limited to any particular face of smart cap 100. The LEDs may be placed at any location in order to alert a user. An example is shown in FIG. 3, where the LEDs 204 are disposed on the side of over cap 104, above USB port 226 discussed below.

Smart cap 100 can also be provided with an LCD display 205 in addition to, or in place of, the LEDs. LCD display 205 can be positioned on the top of the over cap 102, for example, adjacent to the LEDs. The LCD display can perform many functions, such as alerting the user as to when it is time to take his or her medication, indicating the status of the smart cap 100, outputting an error message, and providing dosage instructions.

GPS unit 406 can be used to track the location of the smart cap 100. This data can be used to track the habits of the user.

The smart cap 100 is also provided with a communications module (transceiver) 225 and/or a USB port 226 connected to controller 220. This allows communication with the smart cap 100 remotely or directly. In this manner, any information stored in memory 215 can be downloaded so as to track dispensing times and compliance. These connections can also be used to program the controller when needed, such as when upgrading its software. In addition, USB port 226 can be used to charge rechargeable battery 250 in any known manner.

An alert device will be provided in the smart cap 100 in order to alert a user of the time to take the medication or of errors in the system. The alert device may be an audio alarm, a visual alarm, a vibration alarm, or any combination thereof. The visual alarm may be the light emitting devices (LEDs) 204 or LCD display 205. For example, one of the LEDs glows green when the user is to take a pill and another glows red when it is not yet time for the user to take a pill. The audio alarm will emit an audible signal through speaker 206 when it is time for a user to take a pill and the vibrating alarm (not shown) will vibrate the smart cap 100 when it is time for the user to take a pill.

The visual alarm may be a flashing light or may be a steady light. Further, the audio alarm may emit sound in a pattern, may emit a steady sound or may be an automated voice. Further, the smart cap 100 is not limited to a single type of alert device. The smart cap 100 may contain all three types of alarms, any combination of the three types of alarms, or other alerting devices not discussed herein.

The alarms in the smart cap 100 are not only for alerting a user when to take medication, but can also alert the user if there is a system malfunction. For example, if the battery is getting too low, the smart cap 100 could emit an audio alarm with a sound that differs from the audio alarm sound used to indicate it is time to take medication. Also, the smart cap 100 could emit a different color LED 204 if there is a system malfunction.

The LEDs 204 may also be used to alert the user to what type of medication is in the container 500 capped by the smart cap 100. As an example, if a user is taking a variety of pills, a smart cap 100 for heart medication could glow red, and a smart cap 100 for diabetes medication could glow blue.

The smart cap 100 utilizes communications module (transceiver) 225 to send and receive communications regarding user, prescription, and compliance information. The transceiver may be Zigbee and/or Bluetooth technology, a cell modem, an RFID transmitter, or any other known device for sending and receiving information. Preferably, the smart cap 100 contains more than one transceiver for redundancy. For example, the smart cap 100 preferably contains a cell modem and Bluetooth and/or Zigbee technology.

The cell modem will allow the controller 220 to send messages, via SMS text messages or any other suitable protocol such as TCP/IP, to a central server so as to report compliance data of a user, any malfunctions, any tampering, or any misuse of the pills that is sensed by the smart cap 100. The Bluetooth or Zigbee technology allows for the device to be able to quickly interact with the pharmacy computing system. The pharmacy computer will detect the smart cap 100 and its unique ID and will download any necessary data to the smart cap 100.

Information from the cell modem may also be used by an external server to send messages to any outside source, for example, a user's family or friends, a caretaker, doctor, other healthcare provider, a researcher, pharmaceutical company, a pharmacy for refills, etc., as needed or desired.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A cap for releasably covering a container, the cap comprising:
a first cap section engageable with the container;
a second cap section releasably engageable with the first cap section;
engaging means provided for the first and second cap sections and movable between an engaged position and a released position, the engaging means causing the first cap section to move with the second cap section when in the engaged position, and allowing the second cap section to move relative to the first cap section when in the released position;
a position sensor configured to detect relative positions between the first and second cap sections; and
a controller configured to receive signals from the position sensor and output information based on the received signals.

2. The cap according to claim 1, wherein the position sensor comprises a switch provided on one of the first and second cap sections and an actuator provided on the other of the first and second cap sections.

3. The cap according to claim 1, wherein the position sensor comprises a pair of switches provided on one of the first and second cap sections and an actuator provided on the other of the first and second cap sections, the controller determining the direction of movement of the cap member based on signals received from the pair of switches.

4. The cap according to claim 1, wherein the second cap section is movable relative to the first cap section both in a rotational direction about a rotational axis and in a linear direction along the rotational axis, the engaging means moving between the released and engaged positions when the second cap section is moved in the linear direction.

5. The cap according to claim 1, further comprising a removal sensor for detecting that the cap has been removed from the container.

6. The cap according to claim 1, further comprising a reader for electronically reading identification information of a container to which the cap is or will be attached.

7. The cap according to claim 1, wherein the engaging means comprises complementary lands provided on the first and second cap sections, the land on the first cap section being engaged with the lands on the second cap section when in the engaged position

8. The cap according to claim 1, wherein the position sensor is incorporated in the engaging means.

9. A cap for releasably covering a container, comprising:
a cap section engageable with the container to releasably cover the container;
engaging means provided for the cap section and movable between a first position and a second position, the engaging means allowing the cap section to be removed from the container when in the first position, and not allowing the cap section to be removed from the container when in the second position;
a position sensor configured to detect a relative position of the cap section; and
a controller configured to receive signals from the position sensor and output information based on the received signals.

10. The cap according to claim 9, wherein the position sensor comprises a switch provided on cap section and being engageable with an actuator.

11. The cap according to claim 9, wherein the position sensor comprises a pair of switches provided on the cap section and being engageable with an actuator, and the controller determining the direction of movement of the cap member based on signals received from the pair of switches.

12. The cap according to claim 9, wherein the cap section is movable relative to the container both in a rotational direction about a rotational axis and in a linear direction along the rotational axis, the engaging means moving between the first and second positions when the cap section is moved in the linear direction.

13. The cap according to claim 9, further comprising a removal sensor for detecting that the cap has been removed from the container.

14. The cap according to claim 9, further comprising a reader for electronically reading identification information of the container to which the cap is or will be attached.

15. The cap according to claim 9, wherein the engaging means comprises complementary lands provided on the cap section and the container, the lands on the cap section being engaged with the lands on the container when in the second position

16. The cap according to claim 9, wherein the position sensor is incorporated in the engaging means.

17. A method of releasably covering a container with a cap, the cap comprising at least one cap section engageable with the container, engaging means provided for the at least one cap section and movable between a first position and a second position, the engaging means allowing the cap section to be removed from the container when in the first position, and not allowing the cap section to be removed from the container when in the second position, and a position sensor configured to detect a relative position of the at least one cap section, the method comprising:
receiving signals from the position sensor when the cap is being manipulated, both when the engaging means is in the first position and when the engaging means is in the second position; and
determining a disposition of the cap and outputting information based on the received signals.

18. The method according to claim 17, wherein the cap is determined to be in a removing state when the position sensor sends signals that the engaging means is in the first position and the cap is being rotated in a removing direction.

19. The method according to claim 17, wherein the cap is determined to be tampered with when the position sensor sends signals that the engaging means is in the second position and the cap is being rotated in any direction.
